(19) United States
(12) Patent Application Publication
(10) Pub. No.: US 2025/0140097 A1
(43) Pub. Date: May 1, 2025

(54) MOVING ENTITY TRACKING SYSTEM AND METHOD

(71) Applicant: BizzyPair LLC, Camden, DE (US)

(72) Inventors: Janaina Stad, Camden, DE (US); Jesse Sanchez, Camden, DE (US); Manoj Srinivasan, Camden, DE (US)

(73) Assignee: BizzyPair LLC, Camden, DE (US)

(21) Appl. No.: 18/925,986

(22) Filed: Oct. 24, 2024

Related U.S. Application Data
(60) Provisional application No. 63/546,034, filed on Oct. 27, 2023.

(51) Int. Cl. G08B 21/02; H04N 7/18

(52) U.S. Cl. CPC G08B 21/0261; G08B 21/0211; G08B 21/0277; H04N 7/18

(57) ABSTRACT

A system for monitoring and tracking entities inside and outside a building, wherein a space within and around the building is divided into a plurality of low-priority and high-priority spaces. The system comprises a user device, a first monitor, and a first network. The first monitor coupled to a first entity and configured to transmit and receive wireless signals. The first network includes a plurality of first nodes configured to transmit and receive wireless signals, wherein the first node is wirelessly connected to at least another of the first nodes. The first nodes include a plurality of high-priority first nodes configured to monitor the high-priority spaces. The high-priority first nodes detects the first monitor entering the high-priority space and pushes a notification to the user device regarding the entry of the first monitor into the high-priority space and a location of the high-priority space.

### CROSS-REFERENCE TO RELATED APPLICATION

This application incorporates by reference and claims the benefit of priority to U.S. Provisional Application 63/546,034 filed on Oct. 27, 2023.

### BACKGROUND OF THE INVENTION

### 1. Field of the Invention

The invention relates generally to a device and method for monitoring activity inside and outside a building. More particularly, the invention relates to a device and method for determining, through wireless connection between a monitor wore on an entity and various nodes placed around the building, whether the monitored entity is located in a dangerous or inappropriate location inside or outside the building.

### 2. Description of the Related Art

Children are naturally curious and often restless. When subjected to some adult activities such as, for example, shopping, children have a tendency to wander. In a matter of seconds, while the parent or guardian is distracted, a child can move quickly out of sight and become lost. In most instances, the child is nearby but merely out of sight. In some cases, though, the child may be fall into danger such as an outdoor pool or by abduction.

Thus, there is a need for a system which offers the capability to precisely track the location of children and other individuals (elderlies and animals) inside and outside home to ensure their safety and security.

There is also a need to keep track of the vitals of the individuals to monitor their health and render assistance when necessary.

### BRIEF DESCRIPTION OF THE DRAWINGS

It should be noted that the drawing figures may be in simplified form and might not be to precise scale.

FIG. 1 is a tracking system for monitoring entities inside and outside a building according to a first embodiment of the present disclosure.

FIG. 2 is a block diagram of the tracking system according to a second embodiment of the present disclosure.

FIG. 3 is a block diagram of the tracking system according to a third embodiment of the present disclosure.

FIG. 4 is a block diagram of the first monitor according to a fourth embodiment of the present disclosure.

FIG. 5 is a block diagram of the first monitor according to a fifth embodiment of the present disclosure.

FIG. 6 is a flow chart of a method of monitoring and tracking entities inside and outside a building according to a sixth embodiment of the present disclosure.

### DETAILED DESCRIPTION OF THE INVENTION

The embodiment and various other embodiments can be better understood by turning to the following detailed description, which are presented as illustrated examples defined in the claims. It is expressly understood that the embodiment as defined by the claims may be broader than the illustrated embodiments described below. Many alterations and modifications may be made by those having ordinary skill in the art without departing from the spirit and scope of the embodiments.

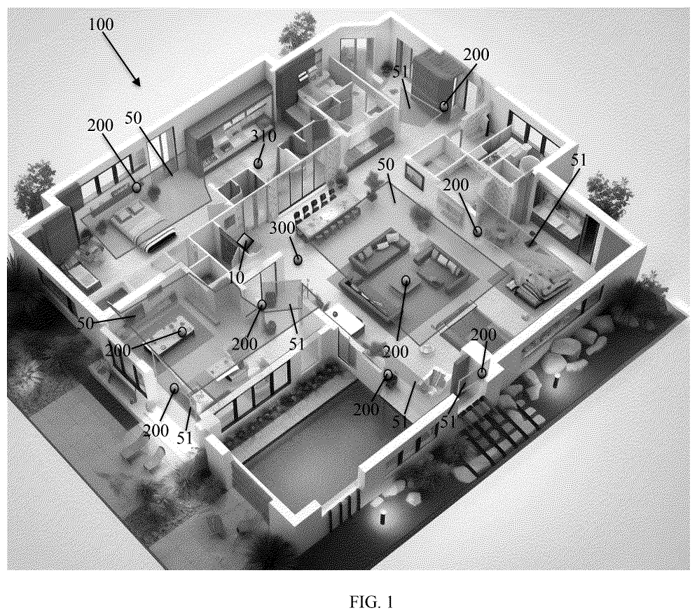

FIG. 1 is a tracking system for monitoring entities inside and outside a building according to a first embodiment of the present disclosure. The entities to be monitored include infants, children, elderlies, other people who need to be constantly monitored, and animals.

In the embodiment illustrated in FIG. 1, the tracking system is implemented in a home 100 whose space is divided into sections of different sizes. The system includes a plurality of nodes 200 disposed in different locations in the home 100, each configured to create a zone 50 and a geofence 51 and wirelessly communicate with other nodes 200. The tracking system further includes a server 10 that can be placed inside the home 100 or somewhere remote from the home 100. The server 10 is configured to wirelessly communicate and exchange data with the nodes 200. The server 10 and nodes 200 together form a network wherein one node 200 is wirelessly connected to at least another node 200 to ensure that no node 200 is isolated from the rest of the network. In the present embodiment, the node 200 is configured to constantly monitor its wireless signal connection with other nodes 200 in the network. Further, the node 200 will attempt to wirelessly connect with any of the nodes 200, if it detects that it has just lost all wireless connection. For instance, in the present embodiment, each nodes 200 is configured to wirelessly connect with two of the nearest nodes 200. However, if the node 200 lost the wireless connection with the previous two nodes, it will try to establish wireless connection with other nodes 200 in the network that are further away than the previous two nodes 200.

The system also includes a wearable first monitor 300 to be wore by the entity (infant, child, elderly, a person to be constantly monitored, or animal) and configured to collect data related to the entity. The data collected by the first monitor 300 include vitals data of the entity and ambient data related to the space occupied by (or proximal) the entity such as temperature and humidity.

The system further includes a user device 310 configured to create and designate zone 50 and geofences 51 in the home 100 using the nodes. In the present embodiment, the user device 310 includes smart phones, personal computer, tablets, and other electronic devices that an adult can use to command the nodes to create and designate a zone 50 or geofences 51 nearby. The user device 310 is wirelessly connected either directly to the nodes 200, indirectly to the nodes 200 via the server 10, or indirectly to the nodes over the internet. The user can then command said node 200 to create a zone 50 or a geofence 51 nearby.

Once the node 200 has created a geofence 51 nearby, it will monitor whether the first monitor 300 has crossed the geofence 51 and log such crossing. The node 200 can issue a notice to the user device 310, whenever the first monitor 300 crosses the geofence 51, via Short Message Service (SMS) or email. Further, the user device 310 can also designate any of the zones 50 as dangerous using one or more node 200 and configure the node 200 to track the length of time the first monitor 300 stays within or remains outside said zone 50 (designated as dangerous). The wireless connection between the above-mentioned server 10, nodes, first monitor 300, and user device 310 can be established using wireless technologies such as mobile phones and the cellular network, satellite, Wi-Fi, Bluetooth, Broadcast Radio, Infrared, Terrestrial (Over-The-Air) Television Broadcasting, and Wireless Chargers.

As illustrated in FIG. 1, the home 100 includes an indoor environment divided into sections of different sizes and some sections (such as kitchen and bathroom) pose more safety risk than the rest. The user of the user device 310 may not always be able to be right next to the entity wearing the first monitor 300. Thus, the user can use the user device 310 and the nodes 200 to create geofences 51 at each entry to the more dangerous section of the home 100. Whenever an entity wearing the first monitor 300 crosses the geofence 51 to a more dangerous zone 50, the corresponding node 200 will detect said crossing and immediately push a warning to the user device 310 so that the user can respond to said crossing either by personally moving to or sending another person to the geofence 51 in question, to ensure that the entity does not remain in the dangerous zone 50. Also, the user can use the nodes 200 to monitor the entity located in a safer section of the home 100 (such as a bedroom) by first using the nodes 200 to designate said safer section as a safe zone 50. The user can then command the nodes 200 to track the length of time the entity and his/her first monitor 300 stays within said safe zone 50.

In the embodiment illustrated in FIG. 1, the tracking system is configured to track one first monitor 300 wore by the entity. In different embodiments, the tracking system of the present disclosure can be configured to track multiple entities (each wearing one of the first monitors 300) inside and outside a specific building.

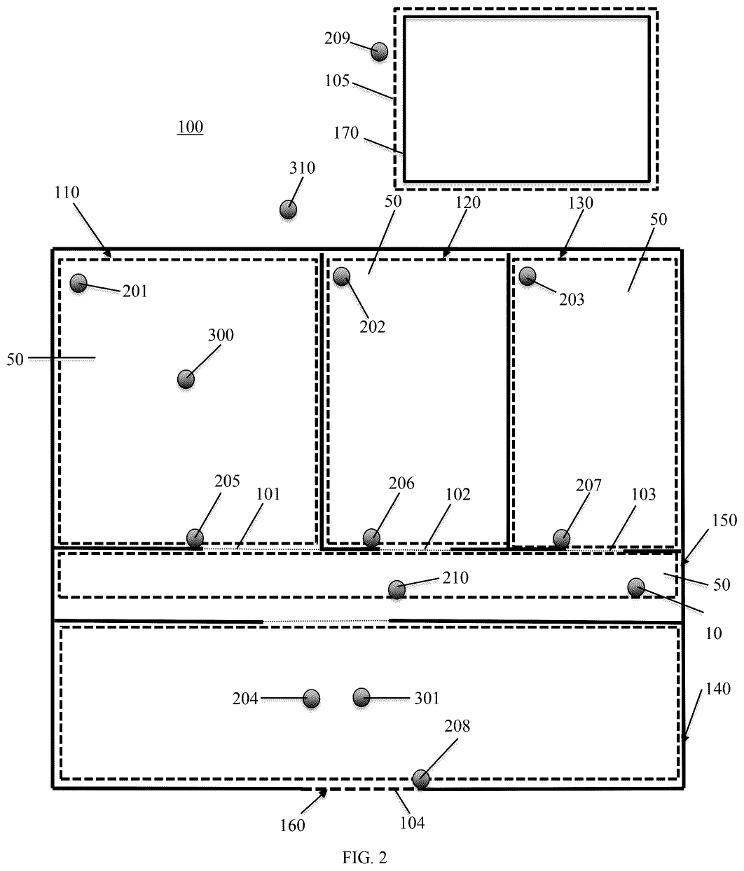

FIG. 2 is a block diagram of the tracking system according to a second embodiment of the present disclosure. The tracking system is implemented in a home 100 whose space is divided into sections of different sizes. The home 100 includes a bedroom 110, a bathroom 120, a kitchen 130, a living room 140, and a corridor 150.

The tracking system includes a plurality of nodes disposed in different locations in the home 100, configured to create zones/geofences, and wirelessly communicate amongst themselves. The system further includes a server 10 that can be placed inside the home 100 (or somewhere remote from the home 100) and configured to wirelessly communicate and exchange data with the nodes 200. The tracking system includes a first node 201 placed inside the bedroom 110, a second node 202 placed inside the bathroom 120, a third node 203 placed inside the kitchen 130, a fourth node 204 placed inside the living room 140, a fifth node 205 placed near the entrance to the bedroom 110, a sixth node 206 placed near the entrance to the bathroom 120, and a seventh node 207 placed near the entrance to the kitchen 130.

The nodes 201-210 form a network wherein one node is wirelessly connected to at least another node to ensure that no node is isolated from the rest of the network. For instance, the first node 201 is configured to monitor and maintain its wireless signal connection with at least the nearest fifth node 205. The first node 201 is configured to establish a new wireless connection with the sixth node 206 if it detects that its previous connection with the fifth node 205 is lost for whatever reason.

In the second embodiment, the tracking system is tasked to monitor a first entity wearing a first monitor 300 and a second entity wearing a second monitor 301. The first entity is a child sleeping in the bedroom 110 and the second entity is another child playing in the living room 140.

The tracking system further includes a user device 310 configured to create and designate safe zones and geofences in the home 100. The user device 310 is wirelessly connected either directly to the nodes 201-210, indirectly with the nodes 201-210 through the server 10, or indirectly with the nodes 201-10 over the internet. The user can choose and command one node to create a geofence nearby. Once the chosen node create a geofence nearby, it will monitor whether the first monitor 300 or the second monitor 301 has crossed the geofence and log such crossing. The node can then issue a notice to the user device 310 whenever one of the first and second monitors 300, 301 crosses the geofence via Short Message Service (SMS), voicemail, device vibration, or email.

Further, the user device 310 can designate one section of the home 100 as a zone 50 using one of the nodes 201-210. The user device 310 can also configure said node to track the length of time the first monitor 300 or the second monitor 301 stays within or remains outside the zone 50.

In the present embodiment, the zone 50 created by the first node 201 (in the bedroom 110) and the zone created by the fourth node 204 (in the living room 140) are both flagged as safe. The first and fourth nodes 201, 204 are also configured to keep track of the length of time the first monitor 300 or the second monitor 301 stays within or remains in the two rooms 110, 140. The user device 310 can also command fifth node 205 to create a first geofence 101 at the entry to the bedroom 110 and monitor whether any of the first monitor 300 crosses the first geofence 101. The fifth node 205 will send a notice to the user device 310 whenever the first monitor 300 crosses the first geofence 101 to notify the user that the first entity wearing the first monitor 300 has woken up and just left the bedroom 110. The fifth node 205 can also notify the user that the second entity wearing the second monitor 301 has crossed the first geofence 101 and enters the bedroom 110.

On the other hand, the zone 50 created by the second node 202 (in the bathroom 120) and the zone 50 created by the third node 203 (in the kitchen 130) are both flagged as dangerous. The user device 310 can command the sixth node 206 to create a second geofence 102 at the entrance to the bathroom 120. The sixth node 206 will send a notice to the user device 310 whenever any of the monitors 300, 301 crosses the second geofence 102 to notify the user that either one of the two entities has entered the bathroom 120, so that the user can reach the bathroom 120 to ensure the safety of the entity in question. Similarly, the user device 310 can command the seventh node 207 to create a third geofence 103 at the entrance to the kitchen 130. The seventh node 207 will send a notice to the user device 310 whenever any of the monitors 300, 301 crosses the third geofence 103 to notify the user that either one of the two entities has entered the kitchen 130 so that the user can reach the kitchen 103 to ensure the safety of the entity in question.

The second node 202 can also keep track of the length of time the monitor 300, 301 crossing the second geofence 102 once and thus remaining in the bathroom 120. The second node 202 will continuously and repeatedly send notification to the user device 310 to alert the user that an entity remains in the bathroom 120. Similarly, the third node 203 will keep track of the time the monitor 300, 301 crossing the third geofence 103 once and remaining in the kitchen 130. The third node 203 will continuously and repeatedly send notification to the user device 310 to alert the user that an entity remains in the kitchen 130.

The tracking system can also monitor entities entering and leaving the home 100. The home 100 includes a front door 160 and the tracking system further includes an eighth node 208 placed near the front door 160. The user device 310 can command the eighth node 208 to create a fourth geofence 104 at the front door 160. The eighth node 208 will send a notice to the user device 310 whenever any of the monitors 300, 301 crosses the fourth geofence 104 to notify the user that either one of the two entities has left the home 100 so that the user can reach the front door 160 to ensure the safety of the entity in question.

The tracking system can also monitor activity outside the house. As illustrated in FIG. 2, the home 100 also includes an outdoor swimming pool 170 and the tracking system includes a ninth node 209 placed near the swimming pool 170. The user device 310 can command the ninth node 209 to create a fifth geofence 105 around the swimming pool 170. The ninth node 209 will send a notice to the user device 310 whenever any of the monitors 300, 301 crosses the fifth geofence 105 to notify the that either one of the two entities has left the home 100 and about to enter the swimming pool 170, so that the user can reach the swimming pool 170 to ensure the safety of the entity in question.

In the present embodiment, the tracking system further includes a tenth node 210 placed in the corridor 150 and configured to track any of the monitors 300, 310 present in the corridor 150. In one scenario where the two entities are both resting in the bedroom 110 and not supposed to be present anywhere else in the home 100, the user can use the user device 310 to command the tenth node 210 to monitor the corridor 150 and alert the user device 310 if any of the monitors 300, 301 leaves the bedroom 110.

The tracking system illustrated in FIG. 2 and discussed above is deployed in a home environment wherein a single user with the user device 310 is responsible for two entities respectively wearing the first and second monitors 300, 310. However, in different embodiments, the tracking system can be deployed in a child care, elderly care environment, animal shelters, zoo, and other places where nodes can create geofences at various entrances, safety zones where entities can stay, and danger/inappropriate zones where no entity should remain. The track system can also include a plurality of user devices each assigned and given to a different guardian/caretaker in the facility, wherein the tracking system can determine if the warning raised by one monitor will be pushed to all user devices or only specific guardian/caretaker assigned with said monitor.

Please note that the first and second monitors 300, 310 are wirelessly connected to at least one of the nodes 201-210 at all times, to ensure that the server 10 and by extension the tracking system is always aware of the locations of the two monitors 300, 310. As mentioned above, every one of the nodes 201-210 is configured to ensure that it's wirelessly connected to at least another node and that the server 10 is constantly receiving updates from every node. Thus, no node and its corresponding zone or geofence is invisible to the server 10 and the rest of the tracking system.

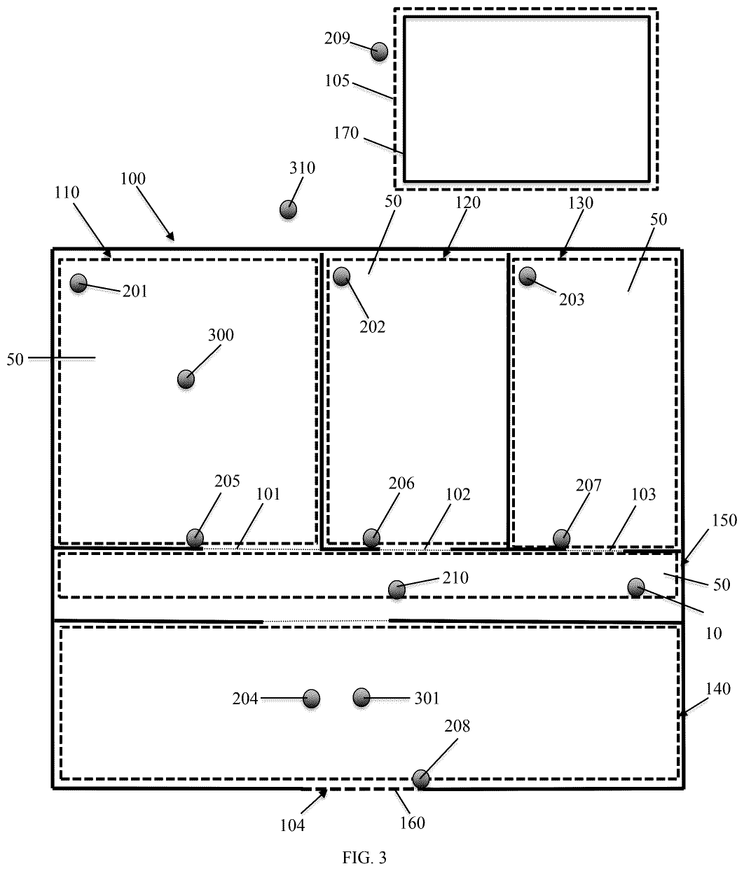

FIG. 3 is a block diagram of the tracking system according to a third embodiment of the present disclosure. The tracking system in FIG. 3 has a flexible hierarchy of monitors, wherein the entity being monitored can also be empowered to monitor another entity at the same.

In the third embodiment, the first entity is a child sleeping in the bedroom 110 and the second entity is an elderly located in the living room 140 and given the task of looking after the child. The child (first entity) is wearing a first monitor 300 and the elderly (second entity) is wearing a second monitor 301, wherein both are monitored by and wirelessly connected with the tracking system of the third embodiment. The first monitor 300 is preferably an electronic bracelet. The second monitor 301 can be an electronic bracelet, smart phone, tablets, and other electronic devices that can generate audio signals and other signals to give notification to the elderly.

The tracking system further includes a user device 310 configured to create and designate safe zones and geofences in the home 100. The user device 310 is located somewhere remote from the home and is wirelessly connected either directly to the nodes 201-210 or indirectly with the nodes 201-210 through the server 10 and over the internet. The user can choose and command one node to create a geofence nearby.

As mentioned above, the elderly wearing the second monitor 301 is given the task of looking after the child (wearing the first monitor 300), while the user with the user device 310 is not at home. Once the node has created a geofence nearby, it will monitor whether the first monitor 300 has crossed the geofence and log such crossing. The node can then issue a notice to the second monitor 301 whenever the first monitor 300 cross the geofence by Short Message Service (SMS), voicemail, device vibration, or email. The elderly (having the second monitor 301) can then check up on the child and make sure that the child is not somewhere he/she should not be. For instance, the fifth node 205 will send a notice to the second monitor 301 whenever the first monitor 300 crosses the first geofence 101 to notify the elderly that the child wearing the first monitor 300 has woken up and just left the bedroom 110. The third node 203 will keep track of the time the first monitor crossing the third geofence 103 once and remaining in the kitchen 130 and send notification to the second monitor 301 to alert the elderly that the child remains in the kitchen 130.

The tracking system of the third embodiment also allows the user having the user device 310 to monitor the location of the elderly having the second monitor 301. For instance, the eighth node 208 will send a notice to the user device 310 whenever the second monitor 301 crosses the fourth geofence 104 to notify the user that the elderly has just crossed the front door 160 so that the user can reach the front door 160 to ensure the safety of the elderly in question. In another example, the ninth node 209 will send a notice to the user device 310 whenever any of the second monitor 301 crosses the fifth geofence 105 to notify the user (having the user device 310) that the elderly has just crossed the front door 160 and about to enter the swimming pool 170, so that the user can reach the swimming pool 170 to ensure the safety of the elderly.

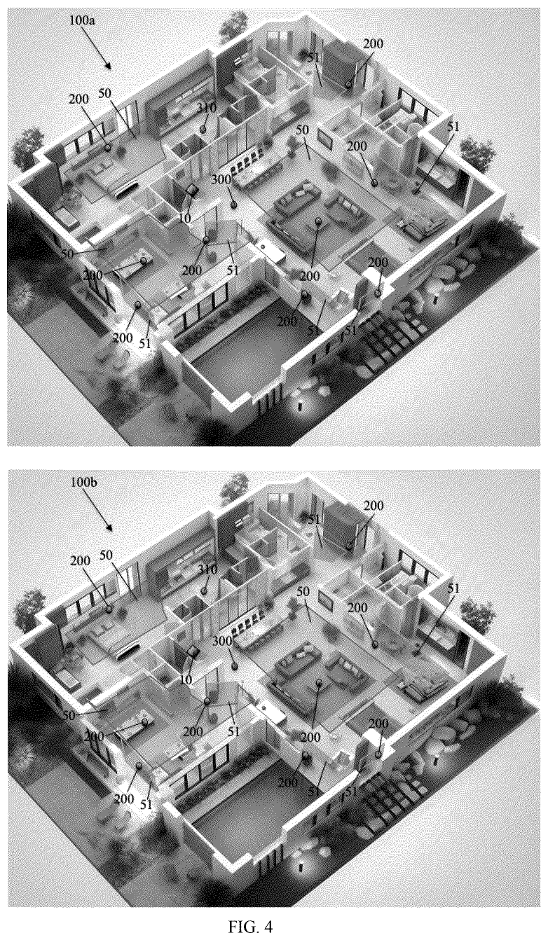

FIG. 4 is a block diagram of the tracking system according to a fourth embodiment of the present disclosure. The tracking system is installed in both the first location 100a and the second location 100b. The tracking system also includes a first monitor 300 configured to automatically establish wireless signal connection with a compatible node 200 in either the first location 100a or the second location 100b. For simplicity sake, the two locations 100a and 100b are structurally identical and includes the same amount of nodes 200. Here, the first location 100a is the home of the monitored child wearing the first monitor 300 and the second location 100b is a home childcare facility. During weekend or after the child care facility is closed, the first monitor 300 will be located in the first location 100a and wirelessly communicate with the nodes 200 and server 10 in the first location 100a. Every warning or notification from the nodes 200 will be pushed to the parent with the first user device 310 at home.

During week days, when the child leaves the first location 100a for the second location 100b in the morning, the first monitor 300 loses all connection with the nodes 200 and server 10 in the first location 100a. However, when the child arrives at the second location 100b, the first monitor 300 will automatically establishes wireless connection with any of the nodes 200 and eventually the server 10 in the second location 100b. The server 10 in the second location then sends a connection confirmation to the second user device 310b (in possession of the caretaker of the home childcare facility) to notify the caretaker that the first monitor 300 is now being monitored by the tracking system in the second location 100b. Similarly, monitors on other children arriving at the second location 100b will also automatically establishes wireless connection with any of the nodes 200 and the server 10 in the second location 100b. Similar to the embodiment in FIG. 2, the caretaker can use the nodes 200 to set up safe zones, geofences to track the location of the various monitors 300 in the second location 100b. If any monitor 300 crosses a geofence to a dangerous section of the second location 100b (such as kitchen and bathroom), the node 200 corresponding to the crossed geofence will notify the caretaker of the location of the monitor so that the caretaker can go to the child in question to ensure his/her safety.

When the child leaves the second location 100b and returns to the first location 100a in the evening, the first monitor 300 loses all connection with the nodes and server in the second location 100b. When the child arrives at the first location 100a, the first monitor 300 automatically establishes wireless connection with any of the nodes 200 and the server 10 in the first location 100a. The server 10 in the first location 100a then sends a connection confirmation to the first user device 310a to notify the parent that the first monitor 300 is now back in the tracking system covering the first location 100a.

Further, data collected by the tracking system of the present disclosure is encrypted and securely hosted on the cloud, to ensure the privacy and security of the tracked individuals and their caregivers. To address privacy concerns, location, vital, and alert data are anonymized using Bluetooth MAC addresses, complying with privacy regulations and requirements.

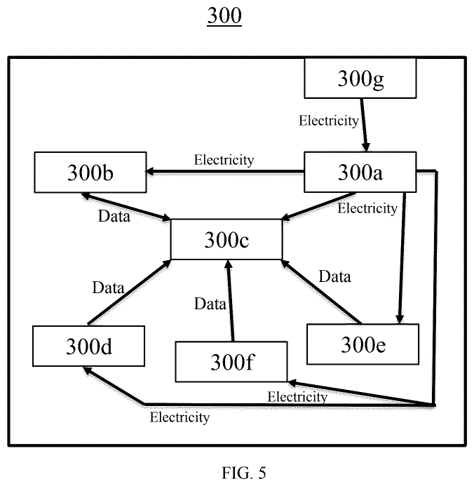

FIG. 5 is a block diagram of the first monitor 300 according to a fifth embodiment of the present disclosure. The first monitor 300 includes a battery 300a, a processor, 300b, a memory 300c, a wireless module 300d, a camera 300e, and a vitals sensor 300f. The battery 300a is electrically connected to the processor 300b, memory 300c, wireless module 300d, camera 300e, and vitals sensor 300f to power them. The battery 300a is preferably a rechargeable battery including lead-acid battery, nickel-cadmium battery, nickel-iron battery, nickel-metal hydride battery, lithium-ion battery, and lithium-ion polymer battery. In the present embodiment, the first monitor 300 also includes a charging port 300g to be electrically connected to a charging cable that allows electricity to flow into the battery 300a and charge its usage. The memory 300c is electrically connected to wireless module 300d, camera 300e, and vitals sensor 300f to receive and store data from said electrical components. The processor 300b is connected to the memory 300c to receive and process data and determine data to send to the server or other nodes in the tracking system using the wireless module 300d.

The wireless module 300d preferably uses only the power-efficient Bluetooth wireless technology to communicate with other wireless devices. However, the wireless module 300d can also use other wireless technologies such as mobile phones and the cellular network, satellite, Wi-Fi, Bluetooth, Broadcast Radio, Infrared, Terrestrial (Over-The-Air) Television Broadcasting, and Wireless Chargers.

In the present embodiment, the camera 300e take images of the surrounding environment at specific events. More specifically, the camera 300e takes picture of the surrounding whenever the first monitor 300 crosses a geofence or enters a dangerous zone and wirelessly communicate with the node corresponding to said geofence or dangerous zone. The wireless module 300d can then send the image data to the server or the nearest node in the tracking system which then determines the location of the first monitor 300 based on the image data as well as other data from the wireless module 300d.

The vitals sensor 300f measures at least one of the following vitals that include body temperature, pulse rate, respiration rate, blood pressure, blood oxygen, weight, and blood glucose level. The processor 300b then send the vitals data from the vitals sensor 300f to the server (using the wireless module 300d) which then determines the physiologic condition of the entity based on said vitals data. The server can also push a warning to the user device on the caretaker to alert him/her that the entity may be having a health emergency that needs immediate attention.

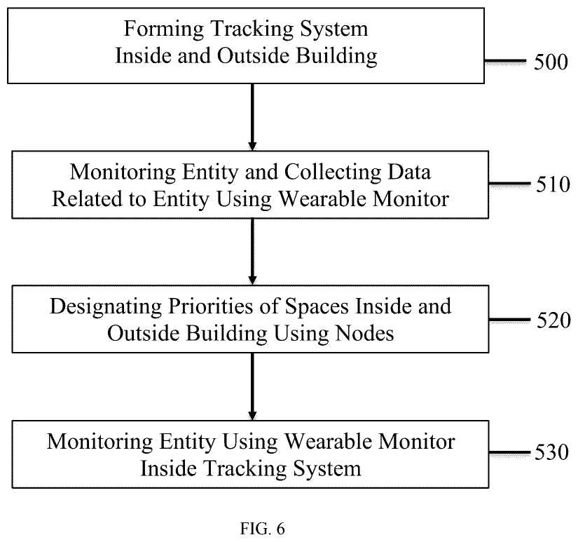

FIG. 6 is a flow chart of a method of monitoring and tracking entities inside and outside a building according to a sixth embodiment of the present disclosure. The method includes step 500 of forming a tracking system inside a building and selectively also outside the building. The building can be a home or a tall building whose space is divided into sections of different sizes. Step 500 includes placing a plurality of nodes in different locations inside the building and selectively also outside the building, wherein the nodes are configured to wirelessly communicate amongst themselves. The nodes form a network wherein one node is wirelessly connected to at least another node to ensure that no node is wirelessly isolated from the rest. In the present embodiment, the node is configured to monitor its wireless signal connection with other nodes in the network. Further, if one node detects that it just lost a wireless signal connection with a first node (for whatever reason), it will attempt to establish wireless signal connection with any other node in the network. Step 500 also includes placing a server inside or remote from the building and configuring the server to wirelessly communicate and exchange data with the nodes.

Step 500 further includes connecting a user device to the nodes and server. The user device includes smart phones, personal computer, tablets, and other electronic devices that an adult can use the nodes to each create and designate safe zones and geofences inside and selectively also outside the home. The user device is wirelessly connected either directly to the nodes, indirectly to the nodes through the server, or indirectly to the nodes over the internet, wherein a user can command one node to create a geofence nearby.

The method further includes step 510 of using a first monitor to monitor the entity (infant, child, elderly, a person who need to be constantly monitored, and animal) and collect data related to said entity. The data collected by the first monitor include vitals data of the entity and ambient data related to the space occupied by (or proximal) the entity such as temperature and humidity. The first monitor is preferably a bracelet or other device configured to be worn by the entity. The first monitor of the present embodiment is identical to the first monitor 300 illustrated in FIG. 5 and discussed above. However, in different embodiment, the first monitor can include smart phones, personal computer, tablets, and other electronic devices that can wirelessly communicate with other electronic devices.

The method further includes step 520 of designating priorities of spaces within and around the building. In the present embodiment, step 520 involves using the user device to create and designate safe zones and geofences in the building such as a regular home. As mentioned above, the home includes an indoor environment divided into sections of different sizes, wherein some sections (such as kitchen and bathroom) posing more safety risk than the rest. The user of the user device may not always be able to right next to the entity wearing the first monitor. Thus, the user can use the nodes to create geofences at each entry to a dangerous section of the home.

The method further includes step 530 of monitoring activity of the entity using wearable first monitor inside and outside the building. Whenever an entity wearing the first monitor crosses a geofence, the corresponding node will detect said crossing and immediately push a warning to the user device so that the user can respond to said geofence crossing either by personally moving to or sending another person to the geofence location to ensure that the entity does not remain in the dangerous section and is not injured. Also, the user can use the nodes to monitor the entity in a safer section of the home (such as bedroom) and use the nodes to create a safety zone in said safer section. The user can then command the nodes to track the length of time the entity and his/her first monitor stays within said safety zone.

For instance, the user device can command a node near the bathroom to create a geofence at the entrance to the bathroom. The node will send a notice to the user device whenever the first monitor crosses the geofence to notify the user that the monitored entity has entered the bathroom, so that the user can reach the bathroom to ensure the safety of the monitored entity.

The tracking system can also monitor entities entering and leaving the home. The home includes a front door and the tracking system further includes a node placed near the front door. The user device can command the node to create a geofence at the front door. The user device can command the node near the front door to create a geofence at said front door. The node will send a notice to the user device whenever the first monitor crosses the geofence (at the front door) to notify the user that the monitored entity has just left the home, so that the user can reach the front door to ensure the safety of the monitored entity.

The tracking system can also monitor activity entities outside the building. The home can include a swimming pool outside and the tracking system further includes a node placed near the swimming pool. The user device can command the node to create a geofence around the swimming pool. The node near the pool will send a notice to the user device whenever the first monitor crosses the geofence around the pool to notify the user that the monitored entity has left the home and about to enter the swimming pool, so that the user can reach the swimming pool to ensure the safety of the monitored entity.

The foregoing descriptions of specific implementations have been presented for purposes of illustration and description. They are not intended to be exhaustive or to limit the invention to the precise forms disclosed, and modifications and variations are possible in view of the above teaching. The exemplary implementations were chosen and described to best explain the principles of the invention and its practical application, to thereby enable others skilled in the art to best utilize the invention and its implementations with modifications as suited to the use contemplated.

It is therefore submitted that the invention has been shown and described in the most practical and exemplary implementations. It should be recognized that departures may be made which fall within the scope of the invention. With respect to the description provided herein, it is submitted that the optimal features of the invention include variations in size, materials, shape, form, function, manner of operation, assembly, and use. All structures, functions, and relationships equivalent or essentially equivalent to those disclosed are intended to be encompassed by the invention.

1. A system for monitoring and tracking entities inside and outside a building, wherein a space within and around the building is divided into a plurality of low-priority and high-priority spaces, the system comprises:
a user device configured to designate priorities to spaces within and around the building;
a first monitor coupled to a first entity and configured to transmit and receive wireless signals;
a first network including a plurality of nodes configured to transmit and receive wireless signals, the node is wirelessly connected to at least another of the nodes, the nodes are distributed inside the building and connected wirelessly to the first monitor,
the nodes include a plurality of low-priority nodes configured to monitor the low-priority spaces, the low-priority nodes monitor the monitor entering low-priority spaces,
the nodes include a plurality of high-priority nodes configured to monitor the high-priority spaces, the high-priority nodes detects the first monitor entering the high-priority space and pushes a notification to the user device regarding the entry of the first monitor into the high-priority space and a location of the high-priority space.

2. The system for monitoring and tracking entities of claim 1 further comprising:
a second monitor coupled to a second entity and configured to transmit and receive wireless signals, the second monitor is connected to the first network; wherein
if the node detects the second monitor entering the high-priority space, the node then pushes the notification to the user device regarding the entry of the second monitor into the high-priority space and a location of the high-priority space.

3. The system for monitoring and tracking entities of claim 1, wherein the first monitor is configured to collect vitals data related to the first entity; if the vitals data indicates a health issue, the monitor pushes a warning to the user device
a) through at least one of the nodes,
b) directly to the user device, or
c) through an internet.

4. The system for monitoring and tracking entities of claim 3, wherein the first monitor includes a sensor configured to collect at least one vital data of the third entity.

5. The system for monitoring and tracking entities of claim 1, wherein the first monitor includes a camera configured to collect images of spaces surrounding the first entity.

6. The system for monitoring and tracking entities of claim 1, wherein if the first monitor loses a connection to one of the nodes the first monitor will attempt to connect with another of the nodes and reestablish connection to the first network.

7. The system for monitoring and tracking entities of claim 1, wherein the first network is connected to the internet, if the first monitor loses a connection to the first network the first monitor will attempt to connect with an internet and reestablish connection to the first network through the internet.

8. The system for monitoring and tracking entities of claim 1, further comprising a second network including a plurality of second nodes configured to transmit and receive wireless signals, the first monitor establishes a connection with at least one of the second nodes if the first monitor loses the connection with all of the nodes of the first network.

9. The system for monitoring and tracking entities of claim 1, wherein the high-priority node creates a geofence at an entrance to the high-priority space, the high-priority node detects the first monitor crossing the geofence and pushes a notification to the user device regarding the first monitor crossing the geofence.

10. The system for monitoring and tracking entities of claim 1, further comprising a server, wherein the nodes includes:
a first node for creating a geofence at an entrance to the high-priority space; and
a second node for monitoring for a presence of the first monitor in the high-priority space;
wherein the first node notifies the server when detecting the first monitor crossing the geofence, the second node notifies the server when detecting the first monitor entering the high-priority space, the server determines the location of the first monitor based on data from the first node and the second node.

11. A method of monitoring and tracking entities inside and outside a first building, wherein a space within and around the first building is divided into a plurality of low-priority and high-priority spaces, the method comprises:
using a user device to designate priorities to spaces within and around the building;
coupling a first monitor configured to transmit and receive wireless signals, to a first entity;
disposing a plurality of nodes within and around the first building;
configuring one of the nodes to be wirelessly connected to at least another of the nodes;
configuring the first monitor to be seek connection to one of the nodes;
placing a plurality of nodes in the low-priority spaces and configuring the nodes to detect the first monitor entering the low-priority spaces;
placing a plurality of nodes in the high-priority spaces and configuring the nodes to detect the first monitor entering the high-priority spaces; and
pushing a notification to the user device regarding the entry of the first monitor into the high-priority space and a location of the high-priority space.

12. The method of monitoring and tracking entities of claim 11, further comprising:
coupling a second monitor configured to transmit and receive wireless signals, to a second entity;
configuring the second monitor to be seek connection to one of the nodes;
configuring the nodes to detect the second monitor entering the high-priority spaces; and
pushing a notification to the user device regarding the entry of the second monitor into the high-priority space and a location of the high-priority space.

13. The method of monitoring and tracking entities of claim 11, further comprising:
configuring the first monitor to collect vitals data related to the first entity; and
pushing a warning to the user device, if the vitals data indicates a health issue,
a) through at least one of the nodes,
b) directly to the user device, or
c) through an internet.

14. The method of monitoring and tracking entities of claim 13, further comprising:
attaching a sensor to the first monitor; and
configuring the sensor to collect at least one vital data of the first entity.

15. The method of monitoring and tracking entities of claim 11, further comprising:
attaching a camera to the first monitor; and
configuring the camera to collect images of spaces surrounding the first entity.

16. The method of monitoring and tracking entities of claim 11, further comprising
configuring the first monitor to establish signal connection with another of the nodes if the first monitor loses signal connection with the previous node.

17. The method of monitoring and tracking entities of claim 11, further comprising
configuring at least one of the node to be wirelessly connected to an internet; and
configuring the first monitor to establish signal connection with the internet to reestablish signal connection with the first network through the internet.

18. The method of monitoring and tracking entities of claim 11, further comprising:
placing a plurality of second nodes in a second building divided into a plurality of low-priority and high-priority spaces,
configuring the first monitor to a connection with at least one of the second nodes if the first monitor loses the connection with all of the nodes of the first network;
configuring the second nodes to detect the first monitor entering the low-priority spaces;
placing a plurality of second nodes in the high-priority spaces and configuring the second nodes to detect the first monitor entering the high-priority spaces; and
pushing a notification to a user device regarding the entry of the first monitor into the high-priority space and a location of the high-priority space.

19. The method of monitoring and tracking entities of claim 11, further comprising:
creating a geofence at an entrance to the high-priority space;
detecting the first monitor crossing the geofence; and
pushes a notification to the user device regarding the first monitor crossing the geofence.

20. The method of monitoring and tracking entities of claim 11, further comprising:
creating a geofence at an entrance to the high-priority space;
notifying a server when detecting the first monitor crossing the geofence;
monitoring for a presence of the first monitor in the high-priority space;
notifying the server when detecting the presence of the first monitor in the high-priority space; and
determining the location of the first monitor based on data from the first node and the second node.
